(19) United States
(12) Patent Application Publication
(10) Pub. No.: US 2025/0055094 A1
(43) Pub. Date: Feb. 13, 2025

(54) BATTERY AND BATTERY MODULE

(71) Applicant: TOYOTA JIDOSHA KABUSHIKI KAISHA, Toyota-shi (JP)

(72) Inventors: Shinya ISHIKAWA, Anjo-shi (JP); Takashi MIURA, Nagoya-shi (JP); Tetsuya MIMURA, Chiryu-shi (JP); Toshihiro SHIMONAKA, Toyota-shi (JP); Yuki HIRATA, Chigasaki-shi (JP); Masayoshi HAGA, Nagoya-shi (JP); Kazuya KUMAZAWA, Nagoya-shi (JP)

(73) Assignee: TOYOTA JIDOSHA KABUSHIKI KAISHA, Toyota-shi (JP)

(21) Appl. No.: 18/638,833

(22) Filed: Apr. 18, 2024

(30) Foreign Application Priority Data
Aug. 8, 2023 (JP) 2023-129554

(51) Int. Cl. H01M 50/176; H01M 50/103; H01M 50/209; H01M 50/249; H01M 50/533

(52) U.S. Cl. CPC H01M 50/176; H01M 50/103; H01M 50/209; H01M 50/249; H01M 50/533; H01M 2220/20

(57) ABSTRACT

The battery cell includes an electrode body in which electrodes and separators are alternately stacked, a battery case in which the electrode body is accommodated, and an electrode lead in which one end is connected to the electrode body inside the battery case and the other end protrudes from an end portion in the width direction of the battery case and is folded back toward the battery case.

### CROSS-REFERENCE TO RELATED APPLICATION

This application claims priority to Japanese Patent Application No. 2023-129554 filed on Aug. 8, 2023, incorporated herein by reference in its entirety.

### BACKGROUND

### 1. Technical Field

The present disclosure relates to a battery and a battery module.

### 2. Description of Related Art

U.S. Unexamined Patent Application Publication No. 2021/0005872 discloses a secondary battery including a battery case in which an electrode assembly is housed and an electrode lead, one end of which is connected to the electrode assembly in the battery case. The other end of the electrode lead protrudes to the outside of the battery case.

### SUMMARY

In the secondary battery disclosed in U.S. Unexamined Patent Application Publication No. 2021/0005872, the other end of the electrode lead protrudes to the outside of the battery case, and therefore the housing space is increased to house the other end of the electrode lead.

In view of the above, an object of the present disclosure is to provide a battery and a battery module capable of reducing the size of a package and increasing the space efficiency during storage.

A first aspect provides a battery including: an electrode body in which electrodes and separators are alternately stacked; a battery case that houses the electrode body inside; and an electrode lead, one end of which is connected to the electrode body inside the battery case and the other end of which protrudes from an end portion of the battery case in a width direction to be folded back toward the battery case.

The battery according to the first aspect includes an electrode body in which electrodes and separators are alternately stacked, a battery case that houses the electrode body inside, and an electrode lead, one end of which is connected to the electrode body inside the battery case. Here, the other end of the electrode lead protrudes from an end portion of the battery case in a width direction to be folded back toward the battery case. Accordingly, the size of a package is reduced in the width direction of the battery case, and the space efficiency during storage can be increased.

A second aspect provides the battery according to the first aspect, in which the other end of the electrode lead includes a folded portion folded back toward the battery case and an extending portion extending from the folded portion toward an upper side of the battery case and protruding from an upper end portion of the battery case.

In the battery according to the second aspect, the other end of the electrode lead includes a folded portion folded back toward the battery case and an extending portion extending from the folded portion toward an upper side of the battery case and protruding from an upper end portion of the battery case.

Accordingly, it is possible to access the battery case from the upper side and connect the electrode lead to a bus bar or the like, and therefore it is possible to perform the work of connecting the electrode lead after housing the battery case in a predetermined housing space. Therefore, it is possible to improve workability and versatility in incorporation into a manufacturing process.

A third aspect provides the battery according to the first or second aspect, in which:
the battery case includes a recessed housing portion in which the electrode body is housed and an outer end portion provided outside the housing portion, the housing portion and the outer end portion being formed on at least one side surface of the battery case in a thickness direction; and
an overlapping width over which the other end of the electrode lead folded back toward the battery case side overlaps the battery case in a thickness direction is narrower than a width of the outer end portion.

In the battery according to the third aspect, the battery case includes a recessed housing portion in which the electrode body is housed and an outer end portion provided outside the housing portion, the housing portion and the outer end portion being formed on at least one side surface of the battery case in a thickness direction. Here, an overlapping width over which the other end of the electrode lead folded back toward the battery case side overlaps the battery case in a thickness direction is narrower than a width of the outer end portion. Therefore, even when the other end of the electrode lead is folded back toward an embossed side surface, the electrode lead can be housed without interfering with the housing portion. As a result, the same design can be applied to both the case where the structure of the battery case is a single-cup embossed structure and the case where the structure is a double-cup embossed structure, for example, and the versatility can be improved.

A fourth aspect provides the battery according to the first or second aspect, in which:
the battery case includes a recessed housing portion in which the electrode body is housed and an outer end portion provided outside the housing portion, the housing portion and the outer end portion being formed on at least one side surface of the battery case in a thickness direction; and
an overlapping width over which the other end of the electrode lead folded back toward the battery case side overlaps the battery case in a thickness direction is wider than a width of the outer end portion.

In the battery according to the fourth aspect, the battery case includes a recessed housing portion in which the electrode body is housed and an outer end portion provided outside the housing portion, the housing portion and the outer end portion being formed on at least one side surface of the battery case in a thickness direction. Here, an overlapping width over which the other end of the electrode lead folded back toward the battery case side overlaps the battery case in a thickness direction is wider than a width of the outer end portion. Therefore, when a plurality of batteries is stacked along the thickness direction of the battery case and housed in a predetermined housing space, for example, the other end of the electrode lead is sandwiched between adjacent battery cases. Accordingly, a gap corresponding to the thickness of the electrode lead can be provided in the center portion of the battery case in the width direction, and expansion and contraction of the battery during charging and discharging can be absorbed by the gap.

When a plurality of batteries are stacked along the thickness direction of the battery case and housed in a predetermined housing space, a predetermined restraining pressure is applied to each battery case along the stacking direction (thickness direction). At this time, the other end of the electrode lead is sandwiched between the adjacent battery cases, so that the restraining pressure at the end portion of the battery case in the width direction is higher than that at the center portion. Accordingly, in the case of a liquid-based battery, it is possible to favorably spread the electrolytic solution to the center portion of the battery case, and it is possible to suppress the occurrence of unevenness in the reaction of the electrode body due to the deviation of the electrolytic solution in the battery case.

A fifth aspect provides a battery module in which the battery according to the first aspect is housed in a module case, in which a plurality of batteries is stacked along a thickness direction of the battery case inside the module case, and the other end of the electrode lead is disposed between adjacent battery cases.

In the fifth battery module, the other end of the electrode lead is folded back toward the battery case, so that the size of a package is reduced in the width direction of the battery case, and a plurality of batteries are stacked along the thickness direction of the battery case inside the module case. Accordingly, the other end of the electrode lead is disposed between adjacent battery cases, and therefore the size of the module case can be reduced in the width direction of the battery case, and the space efficiency during storage of the battery module can be increased.

As described above, with the battery and the battery module according to the present disclosure, it is possible to reduce the size of a package and increase the space efficiency during storage.

### BRIEF DESCRIPTION OF THE DRAWINGS

Features, advantages, and technical and industrial significance of exemplary embodiments of the disclosure will be described below with reference to the accompanying drawings, in which like signs denote like elements, and wherein:

FIG. 1 is a schematic plan view illustrating a main part of a vehicle to which a battery pack according to an embodiment is applied;

FIG. 2 is a schematic perspective view of a battery module according to an embodiment;

FIG. 3 is a plan view of the battery module according to the embodiment, with the upper lid of the module case removed;

FIG. 4 is a schematic view of a battery cell accommodated in a battery module as viewed from a thickness direction;

FIG. 5A is a diagram illustrating a part of a manufacturing process of a battery module, showing a process of folding back electrode leads of a battery cell;

FIG. 5B is a view for explaining a part of a manufacturing process of a battery module, showing a process of inserting an electrode lead into a through-hole of a bus bar;

FIG. 5C is a diagram illustrating a part of a manufacturing process of a battery module, illustrating a process of connecting an electrode lead to a bus bar;

FIG. 6 is a schematic plan view showing a partially enlarged view in which a plurality of battery cells is accommodated in a module case; and

FIG. 7 is a schematic plan view illustrating a modified example of a battery cell, partially enlarged and showing a state in which a plurality of battery cells is accommodated in a module case.

### DETAILED DESCRIPTION OF EMBODIMENTS

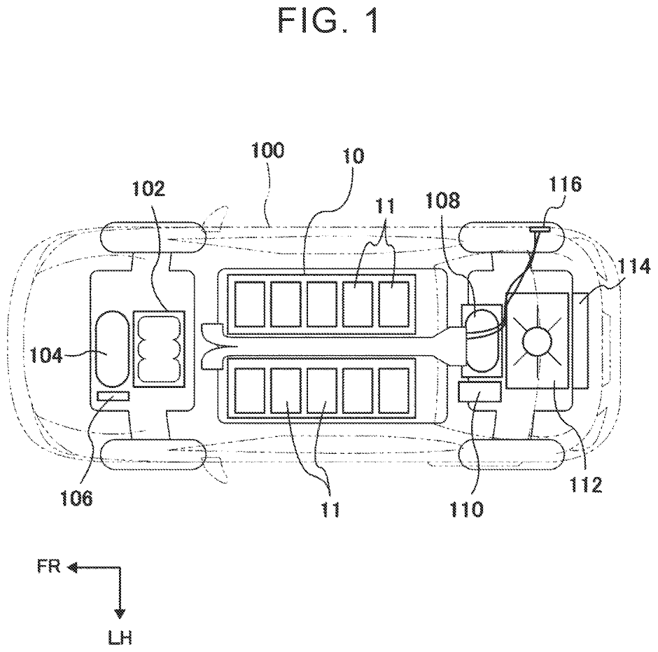

Hereinafter, an embodiment of the present disclosure will be described referring to FIGS. 1 to 6.

### (Overall Configuration of Vehicle 100)

FIG. 1 is a schematic plan view illustrating a main part of a vehicle 100 to which a battery pack 10 according to an embodiment is applied. As shown in FIG. 1, the vehicles 100 are in a battery electric vehicle (BEV where the battery pack 10 is mounted under the floor. Note that the arrows UP, the arrow FR, and the arrow LH in the drawings respectively indicate the upper side in the vehicle up-down direction, the front side in the vehicle front-rear direction, and the left side in the vehicle width direction. In the case where the description is made using the front, rear, left, right, and up and down directions, the front and back directions in the vehicle front-rear direction, the left and right directions in the vehicle width direction, and the up and down directions in the vehicle vertical direction are shown unless otherwise specified.

In the vehicle 100 of the present embodiment, DC/DC converters 102, the electric compressors 104, and Positive Temperature Coefficient (PTC) heaters 106 are arranged in front of the vehicle relative to the battery pack 10. Further, a motor 108, a gear box 110, an inverter 112, and a charger 114 are disposed on the vehicle rear side of the battery pack 10.

The DC current outputted from the battery pack 10 is regulated by DC/DC converters 102 and then supplied to the electric compressor 104, PTC heaters 106, the inverters 112, and the like. Further, electric power is supplied to the motor 108 via the inverter 112, so that the rear wheels rotate to drive the vehicle 100.

A charging port 116 is provided on the right side portion of the rear portion of the vehicle 100, and electric power can be stored in the battery pack 10 via the in-vehicle charger 114 by connecting a charging plug of an external charging facility (not shown) from the charging port 116.

Note that the arrangement, structure, and the like of the components constituting the vehicle 100 are not limited to the above-described configurations. For example, it may be applied to an engine-mounted hybrid electric vehicle (HV) or plug-in hybrid electric vehicle (PHEV). Further, in the present embodiment, the motor 108 is a rear-wheel-driven vehicle mounted on the vehicle rear portion, but the present disclosure is not limited thereto, and the motor 108 may be a front-wheel-driven vehicle mounted on the vehicle front portion, or a pair of motors 108 may be mounted on the vehicle front and rear. Further, the vehicle may be provided with an in-wheel motor for each wheel.

Here, the battery pack 10 includes a plurality of battery modules 11. In the present embodiment, as an example, ten battery modules 11 are provided. Specifically, five battery modules 11 are arranged in the vehicle front-rear direction on the right side of the vehicle 100, and five battery modules 11 are arranged in the vehicle front-rear direction on the left side of the vehicle 100. The battery modules 11 are electrically connected to each other.

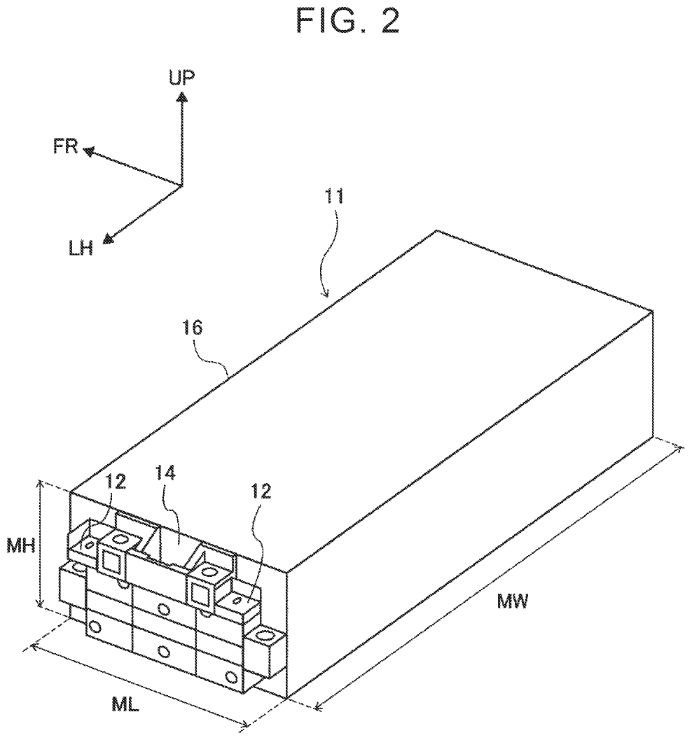

FIG. 2 is a schematic perspective view of a battery module 11. As shown in FIG. 2, the battery module 11 includes a module case 16 that forms an outer shell. The module case 16 is formed in a substantially rectangular parallelepiped shape having a vehicle width direction as a longitudinal direction. The module case 16 is made of an aluminum alloy. For example, the module case 16 is formed by joining aluminum die-casting to both ends of an extruded material of an aluminum alloy by laser welding or the like.

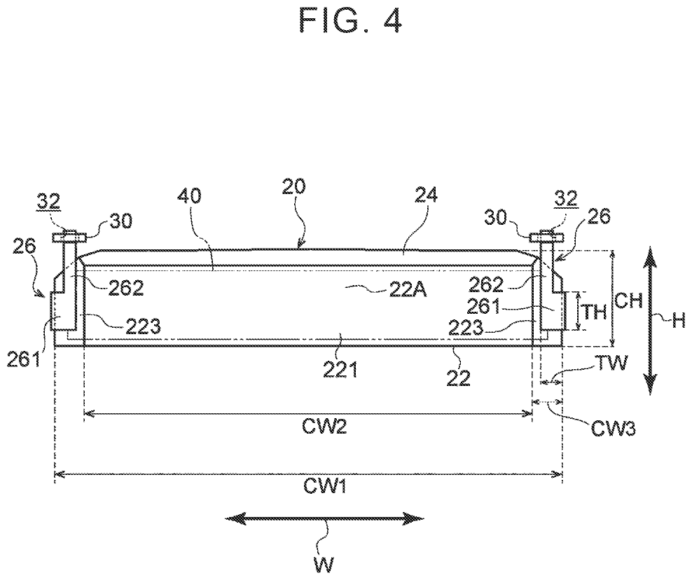

A pair of voltage terminals 12 and a connector 14 are provided at both end portions of the battery module 11 in the vehicle width direction, respectively. A flexible printed circuit board 21, which will be described later, is connected to the connector 14. A busbar 30 (see FIG. 4) is welded to both vehicle-width-direction end portions of the battery module 11.

The length MW of the battery module 11 in the vehicle width direction is, for example, 600 mm from 350 mm, the length ML in the vehicle front-rear direction is, for example, 250 mm from 150 mm, and the height MH in the vehicle vertical direction is, for example, 110 mm from 80 mm.

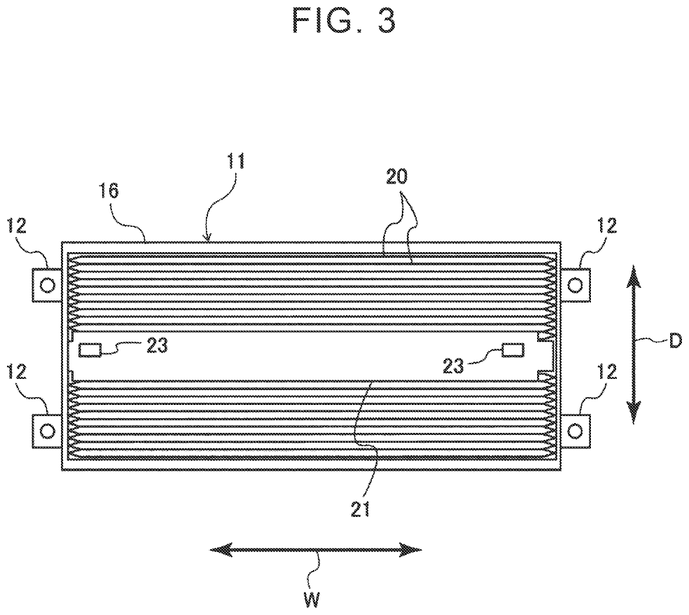

FIG. 3 is a plan view of the battery module 11 with the top removed. As shown in FIG. 3, a battery cell 20 as a battery is accommodated in the module case 16. As an example, a plurality of battery cells 20 are accommodated in a state of being arranged (stacked) in the module case 16. In the present embodiment, the 24 battery cells 20 are arranged in the vehicle front-rear direction and adhered to each other.

For case of explanation, in the views on of FIGS. 3 to 6, the direction indicated by the arrow W is the width direction of the battery cell 20, the direction indicated by the arrow H is the height direction (vertical direction) of the battery cell 20, and the direction indicated by the arrow D is the thickness direction of the battery cell 20.

The width direction of the battery case 22 described later coincides with the width direction W of the battery cell 20. The height direction of the battery case 22 coincides with the height direction H of the battery cell 20. The thickness direction of the battery case 22 coincides with the thickness direction D of the battery cell 20.

A flexible printed circuit board (FPC: Flexible Printed Circuit) 21 is disposed on the battery cell 20. The flexible printed circuit board 21 is formed in a band shape with the vehicle width direction as a longitudinal direction, and thermistors 23 are provided at both end portions of the flexible printed circuit board 21. The thermistor 23 is not adhered to the battery cell 20 and is pressed toward the battery cell 20 by the upper lid of the battery module 11.

One or more cushioning materials (not shown) are accommodated in the module case 16. For example, the cushioning material is an elastically deformable thin plate-shaped member, and is disposed between the adjacent battery cells 20 with the arrangement direction of the battery cells 20 as the thickness direction. In the present embodiment, as an example, cushioning materials are disposed at both end portions in the longitudinal direction of the module case 16 and at a central portion in the longitudinal direction, respectively.

FIG. 4 is a schematic view of the battery cell 20 accommodated in the battery module 11 as viewed from the thickness direction D. As shown in FIG. 4, the battery cell 20 is formed in an elongated rectangular plate shape having a longitudinal direction in the width direction W, and includes a battery case 22 that forms an outer shell. The electrode body 40 is accommodated in the battery case 22. The electrode body 40 is formed by laminating a positive electrode as an electrode, a negative electrode as an electrode, and a separator. In the present embodiment, the battery case 22 is formed of a laminate film, and the electrode body 40 is sealed with the laminate film.

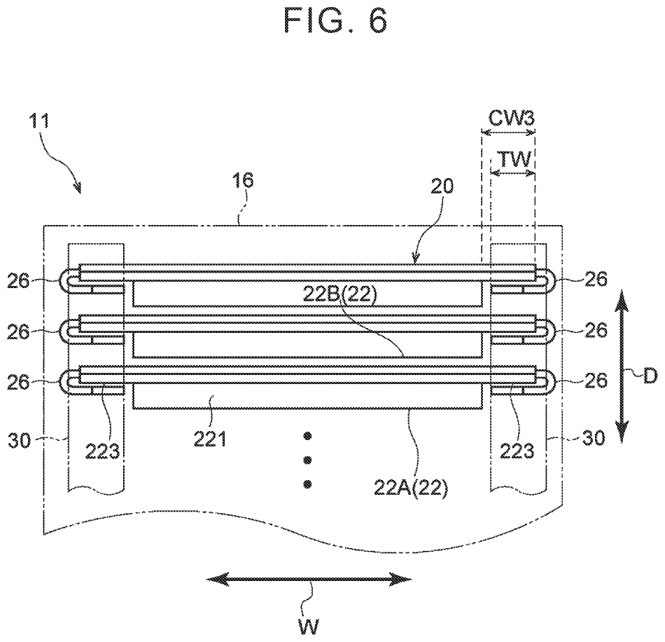

The battery case 22 is embossed in at least one of the thickness directions of the battery case 22. By embossing, a concave housing portion 221 in which the electrode body 40 is accommodated and an outer end portion 223 provided outside the housing portion 221 are formed on the side surface. Note that the battery case 22 may adopt both a single-cup embossed structure in which embossing is performed at one place and a double-cup embossed structure in which embossing is performed at two places, but in the present embodiment, the single-cup embossed structure has a drawing depth 8 mm to a 10 mm degree. Therefore, the battery case 22 has one first side surface 22A in the thickness direction as an embossed surface on which embossing is performed, and the other second side surface 22B in the thickness direction (see FIG. 6) is a non-embossed surface on which embossing is not performed.

The upper end of the battery case 22 in the width direction is bent, and the corners are chamfered to have a substantially trapezoidal shape. Further, the upper end portion of the battery case 22 is bent, and the fixing tape 24 is wound around the upper end portion of the battery case 22 along the width direction.

Here, the battery cell 20 includes an electrode lead 26 protruding from an end portion of the battery case 22. The electrode leads 26 are provided at both end portions in the width direction of the battery cell. In the present embodiment, as an example, the electrode lead 26 is provided at a position offset downward from the center of the battery cell 20 in the height direction H. One end of the electrode lead 26 is connected to the electrode body 40 inside the battery case 22. The other end of the electrode lead 26 protrudes from the end in the width direction of the battery case 22 and is folded back toward the battery case 22.

The other end of the electrode lead 26 has a folded portion 261 folded back toward the battery case 22 side and an extending portion 262 extending from the folded portion 261 toward the upper side of the battery case 22 and protruding from the upper end of the battery case 22. The electrode lead 26 has a substantially L-shape by the folded portion 261 and the extending portion 262. The distal end of the extending portion 262 is joined to the busbar 30 by laser welding or the like. The electrode lead 26 is connected to a wiring outside the battery module 11 via the busbar 30.

The vehicle-width-direction length CW1 of the battery cell 20 is, for example, from 530 mm to 600 mm, the length CW2 of the area in which the electrode body is accommodated is, for example, from 500 mm to 520 mm, and the height CH of the battery cell 20 is, for example, from 80 mm to 110 mm. The battery cell 20 has a thickness of 7.0 mm to 9.0 mm and the height TH of the folded portion 261 of the electrode lead (terminal) 26 is 40 mm to 50 mm.

Further, in the present embodiment, the other end of the electrode lead 26 is set such that the overlapping width TW that is folded back toward the battery case 22 and overlaps the battery case 22 in the thickness direction is smaller than the width CW3 of the outer end portion 223 of the first side surface 22A that has been embossed.

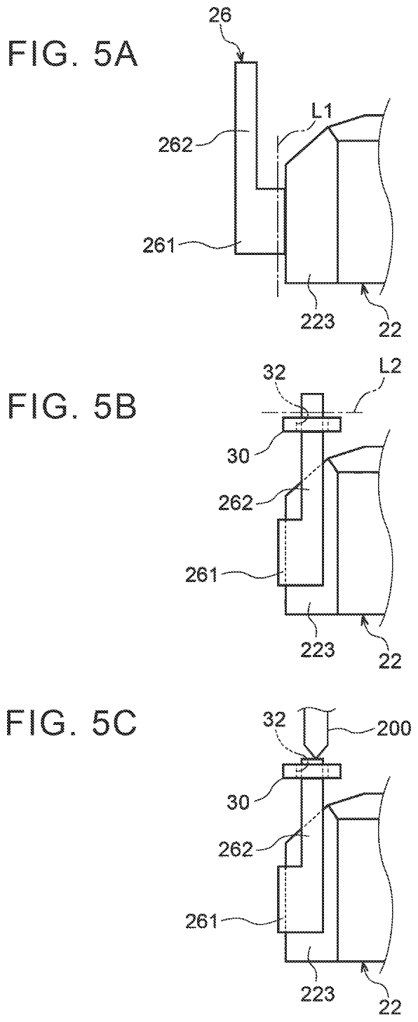

FIGS. 5A to 5C illustrate a part of the manufacturing process of the battery module 11, and show a folding process of the electrode lead 26 and a joining process joined to the busbar 30.

As shown in FIG. 5A, the other end of the electrode lead 26 is folded back at a folded line L1 extending along the end portion in the width-direction of the battery case 22, so that the folded portion 261 is formed at a lower portion in the height direction H.

Next, as shown in FIG. 5B, the busbar 30 is disposed above the battery case 22, and the leading end of the extending portion 262 is inserted into the through hole 32 formed through the busbar 30.

Next, as shown in FIG. 5C, the leading end of the extending portion 262 protruding above the busbar 30 through the through-hole 32 is bent along the folding line L2, and is welded to the upper surface of the busbar 30 by the welder 200 or the like. As a result, the electrode lead 26 and the busbar 30 are joined to each other.

The steps illustrated in of FIGS. 5B and 5C may be performed prior to the step of accommodating the battery cell 20 in the module case 16, or may be performed after the step of accommodating the battery cell 20 in the module case 16.

FIG. 6 is a schematic plan view partially illustrating a plurality of battery cells accommodated in the module case 16 in an enlarged state. As shown in FIG. 6, in the module case 16, a plurality of battery cells 20 are stacked along the thickness of the battery case 22, and the folded portion 261 and the extending portion 262 of the electrode lead 26 are disposed between the adjacent battery cases 22. Note that FIG. 6 is shown with a space between the battery cells 20 for convenience of explanation, but in practice, the plurality of stacked battery cells 20 are in contact with each other via a buffer material or directly, and are restrained from each other with a predetermined restraining pressure applied along the stacking direction (thickness direction D).

In the present embodiment, since the other end of the electrode lead 26 is folded back toward the battery case 22 side, the package of the battery cell 20 is miniaturized in the width direction W, so that the efficiency of the accommodation space in the module case 16 is improved.

Further, since the overlapping width TW between the other end of the electrode lead 26 and the battery case 22 is narrower than the width CW3 of the outer end portion 223 of the battery case 22, a gap is formed between the electrode lead 26 and the housing portion 221 of the battery case 22.

Note that, in the embodiment shown in FIG. 6, the electrode lead 26 is folded back to the first side surface 22A of the battery case 22, or is not limited thereto. The electrode lead 26 may be folded back toward the second side surface 22B.

### Action and Effect

As described above, the battery cell 20 according to the embodiment includes the electrode body 40 in which electrodes and separators are alternately stacked, the battery case 22 in which the electrode body 40 is accommodated, and the electrode lead 26 in which one end is connected to the electrode body 40 inside the battery case 22. Here, the other end of the electrode lead 26 protrudes from the end portion of the battery case 22 in the width direction and is folded back toward the battery case 22. As a result, the size of the package is reduced in the width direction of the battery case 22, and the space efficiency at the time of storage can be increased.

In the embodiment, the other end of the electrode lead 26 includes a folded portion 261 folded back toward the battery case 22 side, and an extending portion 262 extending from the folded portion 261 toward the upper side of the battery case 22 and protruding from the upper end of the battery case 22. Accordingly, the battery case 22 can be accessed from the upper side, and the electrode lead 26 and the busbar 30 can be connected to each other, so that the electrode lead 26 can be connected to the busbar 30 after the battery case 22 is accommodated in the module case 16. Therefore, it is possible to improve workability and versatility in incorporation into a manufacturing process.

Further, in the embodiment, the battery case 22 is embossed on the first side surface 22A of the battery case 22 in the thickness direction, and has a concave housing portion 221 in which the electrode body 40 is housed, and an outer end portion 223 provided on the outer side of the housing portion 221. Here, the other end of the electrode lead 26 has a configuration in which the overlapping width TW that is folded back toward the battery case 22 and overlaps the battery case 22 in the thickness direction is narrower than the width CW3 of the outer end portion 223. Therefore, as shown in FIG. 6, even when the other end of the electrode lead 26 is folded back toward the embossed first side surface 22A, the other end of the electrode lead 26 can be accommodated without interfering with the housing portion 221. As a result, the same design can be applied to both the case where the structure of the battery case 22 is a single-cup embossed structure and the case where the structure is a double-cup embossed structure, and the versatility can be improved.

Further, as in the embodiment, in the battery module 11, a plurality of battery cells 20 are stacked in the module case 16 along the thickness direction of the battery case 22, and the other end of the electrode lead 26 is disposed between the adjacent battery cases 22. Accordingly, the module case 16 can be miniaturized in the width direction of the battery case 22, and the space efficiency when the battery module 11 is accommodated in the battery pack 10 can be increased.

### Modification of the Battery Cell

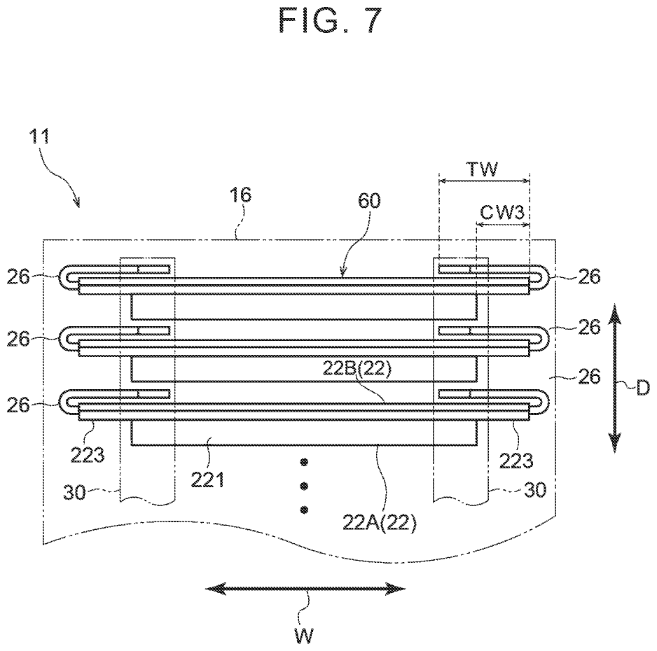

Next, referring to FIG. 7, a battery cell 60 according to a modification of the embodiment will be described. Note that the same components as those in the above-described embodiment are denoted by the same reference numerals, and detailed description thereof will be omitted.

FIG. 7 is a schematic plan view partially showing the plurality of battery cells 60 accommodated in the module case 16 in a partially enlarged manner. As shown in FIG. 7, the battery case 22 constituting the outer shell of the battery cell 60 is embossed on the first side surface 22A of the battery case 22. Thus, the first side surface 22A is formed with a concave housing portion 221 and an outer end portion 223 provided on the outer side of the housing portion 221. The other end of the electrode lead 26 protruding from the end portion in the width direction of the battery case 22 is folded back toward the battery case 22 as in the above-described embodiment.

Note that, in FIG. 7, for convenience of explanation, a space is provided between the battery cells 60, but in practice, the plurality of stacked battery cells 60 are in contact with each other via a buffer material or directly, and are restrained from each other with a predetermined restraining pressure applied along the stacking direction (thickness direction D).

Here, in the present modification, the other end of the electrode lead 26 is configured such that the overlapping width TW, which is folded back toward the battery case 22 and overlaps the battery case 22 in the thickness direction, is wider than the width of the outer end portion 223. Thus, when the plurality of battery cells 20 are stacked and accommodated in the accommodation space in the module case 16 along the thickness direction of the battery case 22, the other end of the electrode lead 26 is sandwiched between the side surfaces of the adjacent battery cases 22. As a result, a gap corresponding to the thickness of the electrode lead 26 can be provided in the center portion of the battery case 22 in the width direction, and the expansion and contraction of the battery cell 20 during charging and discharging can be absorbed by the gap.

Further, when a plurality of battery cells 20 are stacked and accommodated in the accommodation space in the module case 16 along the thickness direction of the battery case 22, a predetermined restraining pressure is applied to the battery case 22 of each battery cell 20 along the stacking direction (thickness direction D). At this time, the other end of the electrode lead 26 is sandwiched between the adjacent battery cases 22, so that the restraining pressure at the end of the battery case 22 in the width direction is higher than that at the center. Accordingly, in the case of a liquid-based battery, the electrolyte can be favorably distributed to the central portion of the battery case 22, and it is possible to suppress the occurrence of unevenness in the reaction of the electrode body 40 due to the deviation of the electrolyte in the battery case 22.

Note that, in the embodiment shown in FIG. 7, the other end of the electrode lead 26 is folded back toward the second side surface 22B which is a non-embossed surface, but the present disclosure is not limited thereto. The other end of the electrode lead 26 may be folded back toward the first side surface 22A as an embossed surface. In this case as well, the other end of the electrode lead 26 is sandwiched between the side surfaces of the adjacent battery cases 22.

Although one embodiment and one modification example have been described above, the present disclosure can be variously modified without departing from the gist thereof. Needless to say, the scope of the present disclosure is not limited to the above-described embodiments.

For example, in the above embodiment and the modification example, the extending portion 262 is integrally formed with the folded portion 261, but the present disclosure is not limited thereto. The extending portion 262 may be formed separately from the folded portion 261 and joined to the folded portion 261 by welding or the like.

Further, for example, in the above-described embodiment and modification, the other end of the electrode lead 26 protruding from one battery case 22 is folded back and arranged between adjacent battery cases 22 in the module case 16, but the present disclosure is not limited thereto. In order to arrange the electrode leads of the adjacent battery cells 20 close to each other, the other ends of the electrode leads 26 protruding from the battery cases may be folded back between the adjacent battery cases.

What is claimed is:

1. A battery comprising: an electrode body in which electrodes and separators are alternately stacked;
a battery case that houses the electrode body inside; and
an electrode lead, one end of which is connected to the electrode body inside the battery case and the other end of which protrudes from an end portion of the battery case in a width direction to be folded back toward the battery case.

2. The battery according to claim 1, wherein the other end of the electrode lead includes a folded portion folded back toward the battery case and an extending portion extending from the folded portion toward an upper side of the battery case and protruding from an upper end portion of the battery case.

3. The battery according to claim 1, wherein: the battery case includes a recessed housing portion in which the electrode body is housed and an outer end portion provided outside the housing portion, the housing portion and the outer end portion being formed on at least one side surface of the battery case in a thickness direction; and
an overlapping width over which the other end of the electrode lead folded back toward the battery case side overlaps the battery case in a thickness direction is narrower than a width of the outer end portion.

4. The battery according to claim 1, wherein: the battery case includes a recessed housing portion in which the electrode body is housed and an outer end portion provided outside the housing portion, the housing portion and the outer end portion being formed on at least one side surface of the battery case in a thickness direction; and
an overlapping width over which the other end of the electrode lead folded back toward the battery case side overlaps the battery case in a thickness direction is wider than a width of the outer end portion.

5. A battery module in which the battery according to claim 1 is housed in a module case, wherein a plurality of batteries is stacked along a thickness direction of the battery case inside the module case, and the other end of the electrode lead is disposed between adjacent battery cases.
